(19) United States
(12) Patent Application Publication
(10) Pub. No.: US 2007/0124345 A1
(43) Pub. Date: May 31, 2007

(54) Library backup

(76) Inventors: Kathy K. Heinz, Maple Valley, WA (US); Rohinton N. Mistry, Issaquah, WA (US); Christopher M. Clawson, Maple Valley, WA (US); Hans Schumacher, Kent, WA (US)

Correspondence Address: John S. Beulick;Armstrong Teasdale LLP, Suite 2600, One Metropolitan Square, St. Louis, MO, 63102, US

(21) Appl. No.: 11/290,359

(22) Filed: Nov. 30, 2005

(51) Int. Cl. G06F 17/30

(52) U.S. Cl. 707/204

(57) ABSTRACT

Systems and methods are disclosed for a library backup. The disclosed systems and methods may include requesting backup information from an external library by the user. Furthermore, the disclosed systems and methods may include packaging the requested information into an archive file and storing the archive file having a first data format in a user directory. Moreover, the disclosed systems and methods may include converting the archive file having a first data format into a backup file having a second data format and sending the backup file to the user, wherein the user can use the information within the backup file locally.

### BACKGROUND

I. Field of the Invention

The present invention generally relates to a system and method employing a process for backing up information in the data storage of a local system that is normally stored and maintained in a remote library host system. More particularly, the present invention relates to a system operatively configured for preemptive library backup of files stored and maintained at a remote library host system. The backup process is necessitated because files to which it is critical to have immediate access may not be accessible because the communications link between the local system and the library host system is temporarily unavailable.

II. Background Information

Many companies maintain central resource libraries where all types of data concerning products and or services are stored and maintained electronically. Such data includes manuals, solutions, product specifications etc. Because information of this type is constantly changing, a centralized resource library is one method of providing efficient, cost effective and uniform dissemination of such information. In many instances, information is disseminated by providing any person that may need access to information within the library such access via an Internet, virtual private network, or wide area network connection. One of the problems with accessing a central resource library via remote connections is that the connections occasionally become unavailable. If the information an individual seeks is of an urgent nature, and the user's system cannot establish a connection, the information cannot be accessed, resulting in lost opportunities, at least up until the connection is reestablished. In view of the foregoing, there is a need for a system and method allowing a user to maintain access to information that is normally not accessible when a communications link connecting the user and the remote library cannot be established.

### SUMMARY

Consistent with embodiments of the present invention, systems and methods are disclosed for a library backup.

In accordance with one embodiment, a method for delivering backup information to a user, comprising requesting backup information from an remote library host system by the user, packaging the requested information into an archive file, storing the archive file having a first data format in a user directory, converting the archive file having a first data format into a backup file having a second data format, and sending the backup file to the user, wherein the user can use the information within the backup file locally.

According to another embodiment, a computer-readable medium which stores a set of instructions which when executed performs a method for delivering backup information to a user, the method executed by the set of instructions comprising requesting backup information from an external library by the user, packaging the requested information into an archive file, storing the archive file having a first data format in a user directory, converting the archive file having a first data format into a backup file having a second data format, and sending the backup file to the user, wherein the user can use the information within the backup file locally.

In accordance with yet another embodiment, including a local system and remote library system, configured to deliver backup information to a user following a request for backup information from an external library by the user. The system packages the requested information into an archive file, stores the archive file having a first data format in a user directory, converts the archive file having a first data format into a backup file having a second data format, and sends the backup file to the user, wherein the user can use the information within the backup file locally.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a diagram illustrating an exemplary system architecture for delivering backup information to a user, according to one embodiment.

FIG. 2 is a diagram illustrating an alternative exemplary system architecture for delivering backup information to a user, according to one embodiment.

FIG. 3 is a flowchart illustrating an exemplary method for delivering backup information to a user, which can be implemented by the system architecture of FIG. 1, according to one embodiment.

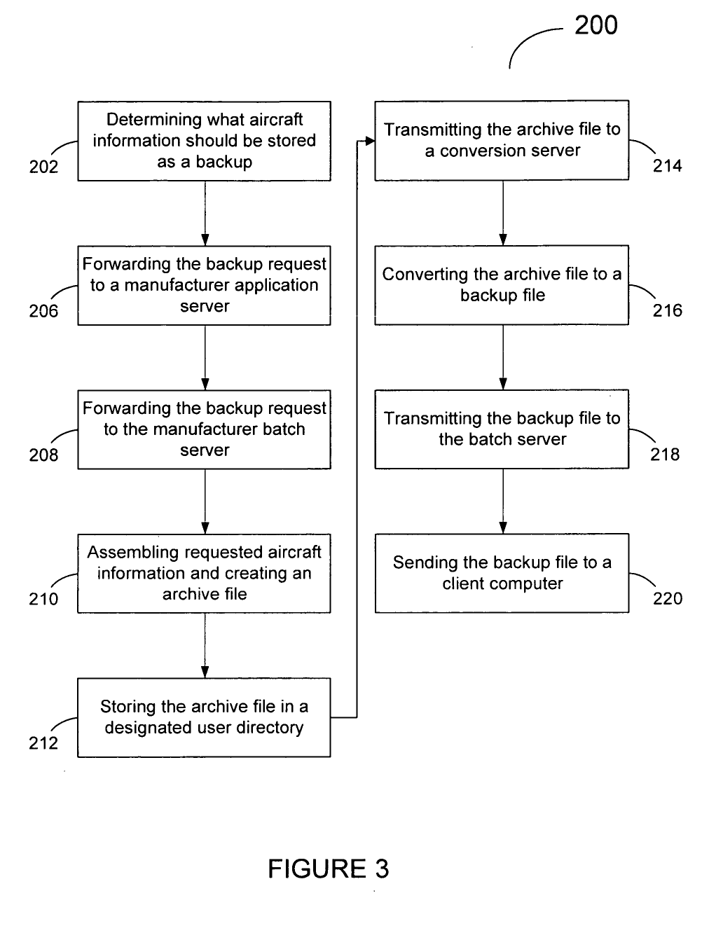

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects.

The logical operations of the various embodiments are implemented (a) as a sequence of computer implemented steps running on a computing system and/or (b) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. The following detailed description is, therefore, not to be taken in a limiting sense. Instead, the proper scope of the invention is defined by the appended claims.

The following detailed description refers to the accompanying drawings. Wherever possible, the same reference numbers are used in the drawings and the following description to refer to the same or similar parts. The library backup systems and methods allow users to automatically download backup files of select documents to their own local storage media in a viewable format. In the present embodiment, it is preferred to store the backup files in a PDF format. These documents may be used as backup files when a communications link between the users local system and a remote library is unavailable. Accordingly, for example, a system user requesting information concerning maintenance specifications for an aircraft may access a remote central resource library and backup select files relating to aircraft maintenance by storing designated files on the local system of the system user. Because the select files are stored as PDF documents, they can be printed and used to perform maintenance tasks at an aircraft, which, for example, may be at an aircraft in a hangar. When computers systems housed in the hangar cannot establish a link to the central resource library to acquire the documents necessary to perform maintenance tasks due to a disruption in the communications link, the user simply access the files from local data storage.

Using the library backup system, a user can designate certain documents for backup (a backup request). The backup request can be forwarded to an application server, which facilitates the packaging of the requested documents into an archive file for storage in a specified directory. The archive file can subsequently be extracted from storage and transferred to a conversion server that converts the archive file into a backup file that is in a displayable format. The backup file may then be transferred to a user's local computer or a group server to which the user's local computer is networked. In one embodiment, the transfer of backup files to a user's local computer or a group server is implemented by transferring the backup files back to the application server for storage in the specified directory. Once in the specified directory, the backup file is accessible to the user and can be transferred to the user's local computer or a group server via an active download process initiated by the user or via a subscription process facilitating an automatic download. When backup files are loaded on the user's local computer, the user may then install the backup file on the group server where it is available for use, viewing and printing by others on local workstations networked to the group server. Once installed on the user's local computer, the backup file can be recalled and used when communications with a central resource library cannot be established. In an alternative embodiment, the transfer of backup files to a user's local computer or a group server is implemented by transferring the backup files directly from the conversion server to the user's local computer or a group server. This direct transfer may be an active download process initiated by the user or an automatic download that occurs via a subscription process.

It is contemplated that the present system and method shall be implemented in an aircraft carrier and manufacturer environment. In the context of maintaining its fleet of aircraft, employees of the carrier performing maintenance on the aircraft may need to access the central resource library to gain access to maintenance information. In many instances, aircraft maintenance personnel know problems that need to be resolved prior to the aircraft landing because of the aircraft onboard systems.

In order for a maintenance session to be successful, the amount of time an aircraft spends on the ground/in the hangar needs to be minimized. One aspect of achieving this objective is to make sure all components and information necessary for maintenance are readily available when the aircraft arrives for maintenance. The present invention helps to achieve this objective by providing a system and process that removes the delays associated with maintenance resulting from unavailable information due to inability to access the information hosted within a central resource library.

More specifically, for example, a user may request documents relating to a specific aircraft from the central resource library of an aircraft manufacturer. Often such information requests and receipt of documents are transmitted and received via the Internet. The present invention provides a solution for the instances when the user may request documents for storage locally as a backup in order to maintain company operations during a period in which an Internet connection cannot be established. The solution provides a system that is configured to allow the backup of data files to occur automatically for the company. The company may be involved in a mission critical process; for example, a diagnostic test being performed before an aircraft is permitted to leave a terminal. Information concerning the diagnostic test may be essential to company maintenance crews in performing their tasks, and if such information cannot be accessed due to an Internet disruption, delays in company operations could occur.

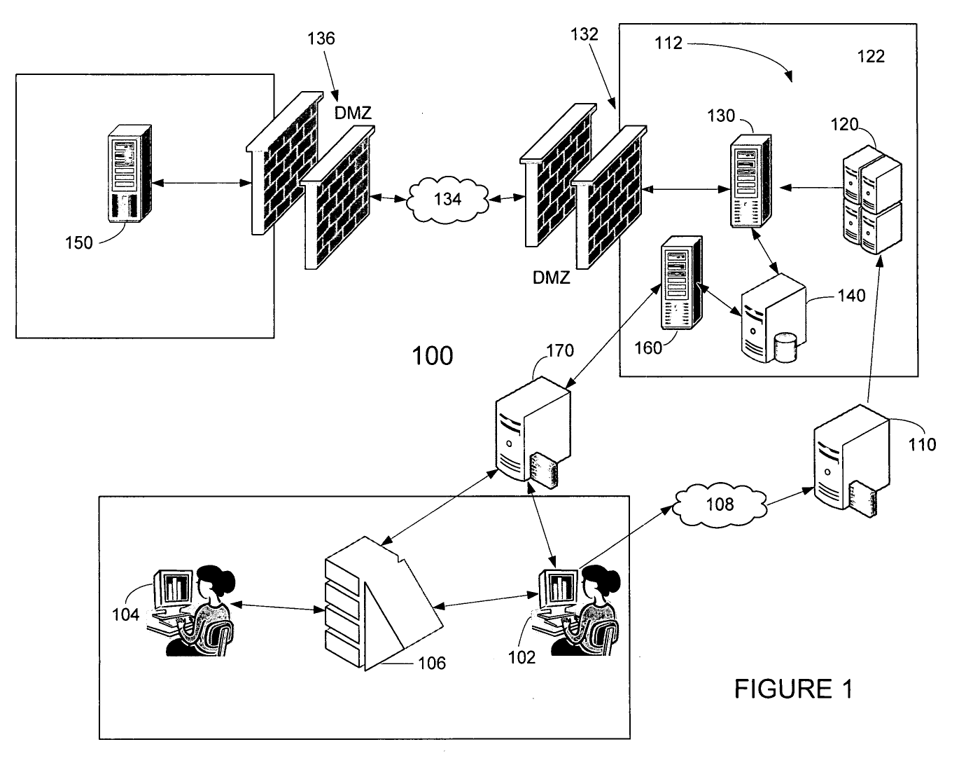

FIG. 1 is a diagram illustrating an exemplary system architecture 100 for delivering backup information to a user, according to one embodiment of the present invention. The system architecture 100 may include a client computer 102, a reverse proxy server 110, web application server 120, a batch server 130, a storage device 140, a second application (conversion) server 150, a document delivery server 160, a document delivery proxy server 170, user server 106, and user computer 104. The system architecture 100 is configured to provide a user 102 within a remote library 122 configured with web applications that allow storage of back up files in local that storage of a computer of a user that accesses the remote library. The proxy server 110 serves as a computer network device that allows users, through computers such as client computer 102, to make indirect network connections to the remote library system 122 of an airline manufacturer. Accordingly, a user connects via client computer 102 to the proxy server 110, which facilitates authentication to ensure that the user is allowed limited access to only those applications within the application server 120 to which is permitted access.

As FIG. 1 illustrates, the client computer 102 may be used by a user, for example, an employee for an airline company, to communicate with the systems of an airline manufacturer 122. The client computer 102 connects to the reverse proxy server 110, and the application server 120. The application sever 120, which communicates with the batch server 130, is configured to facilitate web applications and performs as a toolbox of options that the user engages to acquire and transmit information to and from the resource library 122. The application server 120 provides a user interface, for example, a graphical user interface (GUI), for selecting documents the user desires to receive as backup files. In one embodiment, the GUI can provide a screen having thumbnails for each document that may be selected by the user. The user may subsequently select the thumbnail of the document desired as a backup file. The application server 120 forwards the user's selection of documents to the batch server 130, which access the data from data storage 140 and reconfigures it into a viable format. It is contemplated that the format may be any viewable format workable throughout this solution. However, in the present embodiment, the format of the data is XML. The XML formatted data is then transmitted from the batch server 130 to the application server 120, where it is displayed to the user. Within this display, application server 120 has functionality that allows the user viewing the displayed XML formatted document to modify the data and/or insert there own text. Upon completion of editing by the user, that modified XML file is transmitted back to the batch server and stored within the a specified directory associated with the user within data storage 140. Next, a command is made to backup the XML file along with the modifications, causing the file to be extracted from data storage 140 by the batch server 130 and transmitted to the conversion server 150. Conversion server 150 processes the XML file(s) and converts them to PDF format. Next, the conversion server 150 transmits the PDF files back to the batch server 130, where the PDF files are stored in the client specified location within data storage 140 as backup files. The files stored within data storage 140 as PDF documents are automatically transmitted to the client computer 102, which has been configured to pull down such data at predetermined intervals. The client computer 102 is provided with an application that configures it with the capability to periodically transmit an inquiry as to whether there are any backup files stored in the client associated location within data storage 140. The inquiry from client computer 102 is made via a download proxy server 170 that communicates with a download server 160 that accesses the data within the client specified location with data storage 140.

When a user accesses the remote resource library 122 to make a request for specified files to be backed up, the connection is made via the application server 120. The application server communicates with the batch server 130, which communicates with the storage device 140 and the conversion server 150. The batch server 130 addresses the request from the application server 120 by acquiring the requested information from the storage device 140, which in the present embodiment, houses information related to aircrafts manufactured by the manufacturer, for example, Boeing 747 aircraft maintenance documents. The documents can be stored in a format designated by the manufacturer; for example, the documents can be stored in an Extensible Markup Language (XML) format. Once the batch server 130 acquires the requested information from the storage device 140, the batch server 130 packages the documents and stores the packaged documents as an archive file in a directory designated for the company within storage device 140.

Once an archive file is placed in its designated directory within storage device 140, the batch server 130 can send the archive file to the conversion server 150. Once the conversion server 150 receives the archive file, the conversion server 150 may convert the archive file into a backup file having a format more appropriate for use as a backup file. The conversion server 150 may create a backup file, which is formatted in a portable document format (PDF).

When converting the archive file to a backup file, the conversion server 150 employs several components: a print component (not shown), a rendering component (not shown) and a packaging component (not shown). The print component of the conversion server 150 can prepare the data within the archive file for conversion into a backup file. The rendering component of the conversion server 150 can provide a rendering of the data from the print component and converts the data into a backup file having a format that is not the same as the archive file, for example, a PDF format. The rendering component may use style sheets for determining how the archive file having one format can be converted into a backup file having different format. The packaging component can assemble the data that has been converted into a PDF format and create a backup file from the data.

Once a backup file has been created by the conversion server 150, the conversion server 150 may transmit the backup file to the batch server 130. Communications between the batch server 130 and the conversion server 150 occur via a secure connection. In the present embodiment, the connection 134 between the batch server 130 and the conversion server 150 is via a secure virtual private network connection. It is contemplated that the secure connection 130 may also be via a secure Internet and a secure wide area network connection. The batch server 130 and the conversion server 150 may also employ demilitarized zones 132, 136 (DMZ) to prevent access to servers which may house sensitive information.

Once the batch server 130 receives the backup file from the conversion server 150, the backup file is stored in the company's designated user directory within data storage 140. The backup files stored within data storage 140 may be transmitted to the client computer 102 or a user server 106 via a document delivery server 160 that is connected to a document delivery proxy server 170, which is connected to a client computer 102 or a user server 106. In the present embodiment, the user sets up the client workstation 102, the document delivery server 160 and the document delivery proxy server 170 for subscription service by installing the appropriate piece of a document delivery software application called TrueDelivery. TrueDelivery is a software application that is licensed by Radiance Technologies, Inc. Radiance Technologies' TrueDelivery software application controls document delivery from data storage 140 to the client computer 102 via a document delivery server 160 and a document delivery proxy server 170. The subscription service implemented by TrueDelivery facilitates automatic delivery of files stored within the company's designated directory within data storage 140 to the client computer 102. Set up of the client workstation 102 is accomplished by installing a TrueDelivery software client control application module on the client workstation 102. Set up of the document delivery server 160 is accomplished by installing a TrueDelivery software collaboration application module on the document delivery server 160. Set up of the document delivery proxy server 170 is accomplished by installing a TrueDelivery software proxy delivery application module on the proxy delivery server 170. With the configuration illustrated in FIG. 1, the client computer 102 can conduct a periodic polling of document delivery server 160 via document delivery proxy server 170 and thereby access the company's designated user directory within data storage 140 and facilitate the automatic download of backup files newly received from the conversion server 150. For example, if the user sets up subscription service to have files within the company's directory to be delivered to the client workstation 102 every fifteen minutes, a download sequence for all files would occur every fifteen minutes. The subscription service provides the option of designating the client workstation 102 or the user server 106 for document delivery. It is also contemplated that the user server 106 may be configured with TrueDelivery software whereby the server performs periodic polling of document delivery server 160. Because the client computer 102 has access to documents with the company's designated directory within data storage 140, the client computer 102 can download the backup files stored in the company's designated user directory using Radiance Technologies' content delivery manager software called TrueDelivery.

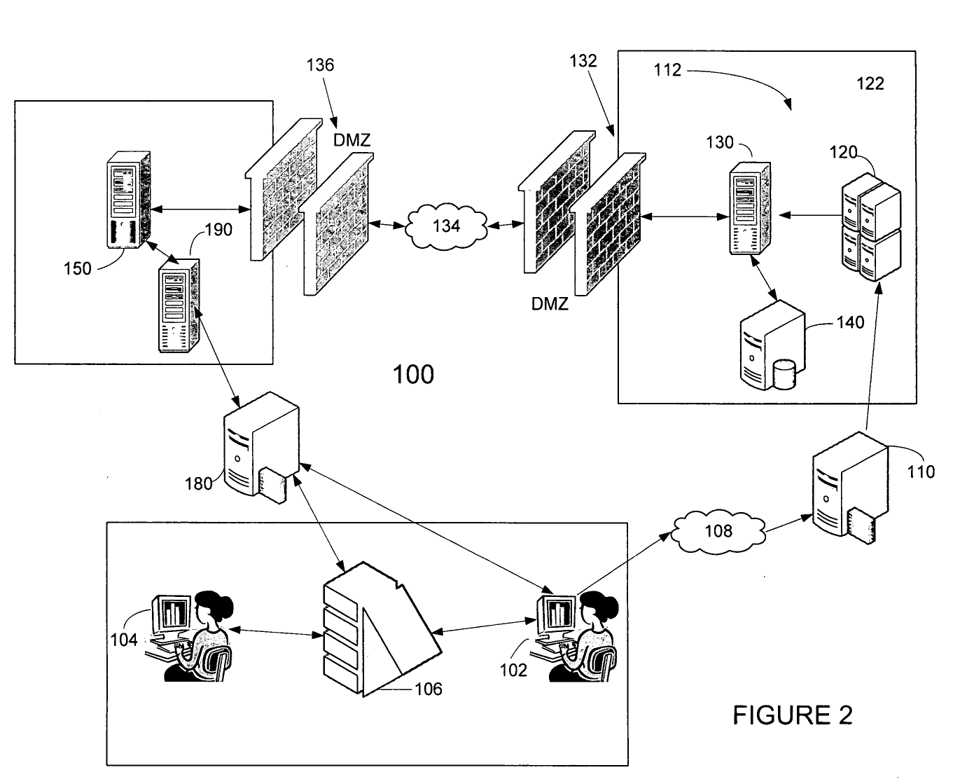

In an alternative embodiment illustrated in FIG. 2, once a backup file has been created by the conversion server 150, the conversion server 150 stores the backup files in a designated user directory within data storage within conversion server 150. The backup files stored within the designated user directory in conversion server 150 may be transmitted to the client computer 102 or a user server 106 directly via a document delivery server 180 that is connected to a document delivery proxy server 190, which is connected to a client computer 102 or user server 106. Similar to the setup of the client computer 102, document delivery server 160 and document delivery proxy server 170, of FIG. 1, the client computer 102, document delivery server 180 and document delivery proxy server 190 of FIG. 2 are setup.

Once the client computer 102 receives the backup file, the user may transmit the backup file to the user server 106 for storage. Once the backup file is stored on the user server 106, company employees can have access to the data from the backup file using the user computer 104. A company may use one or more user computers 104. The user may also produce a compact disc (CD) or use some other form of portable storage device, for example, a Universal Serial Bus (USB) portable storage device. The user may also print the data from the backup file for storage as a hardcopy.

FIG. 2 illustrates a flowchart illustrating an exemplary method 200 for delivering backup information to a user that can be implemented by the system architecture of FIG. 1, according to one embodiment. Method 200 begins at step 202 where a user, for example, an airline employee, can determine which aircraft information should be stored locally. For example, the user could determine that maintenance information for a specific aircraft fleet should be stored locally for use by maintenance technicians. Alternatively, because it is known that certain tests need to be run on the aircraft when it lands in order for it to be cleared for flight again, it is advantageous to store the documents associated with such tests, just in case the internet connection is down and the information cannot be accessed. Next, the user can send a backup request to the aircraft manufacturer central resource library 122 using the client computer 102. The user uses a graphical user interface application on the application server which configures selectable thumbnail icons associated with given document in order to facilitate selection of the documents desired by the user to be backed up. The backup request is transmitted from the client user 102 to the systems of an airline manufacturer 112 using, for example, the Internet.

At step 206, the backup request may be forwarded from the reverse proxy server 104, which initially receives the backup request to the application server 106 for processing. Next at step 208, the application server 106 may forward the backup request to the batch server 108. At step 210, the batch server 108 can assemble the requested information using the storage device 110 and package the requested information to create an archive file. Next at step 212, the archive file is stored in data storage 140 in a company designated user directory in a file format designated by the manufacture, for example, XML.

At step 214, the archive file may be transmitted to conversion server 120. Next at step 216, the conversion server 120 may convert the archive file into a backup file. The conversion server 120 creates a backup file, which may be in a displayable format, by assembling and packaging data converted from the archive file. The backup file has a data format that may be different from the archive file, for example, a PDF format. At step 218, the conversion server 120 may transmit the backup file to the batch server 108. The Internet may be used for both file transmissions between the batch server 108 and the conversion server 120.

At step 220, the batch server 108 can transmit the backup file to the client computer 102. Once the client computer 102 receives the backup file, the user may use the backup file to maintain airline operations by utilizing the information contained in the backup file if communications cannot be established between the airline company and the aircraft manufacturer. Thus, mission critical operations may still be conducted using the information from the backup file even though the airline company cannot communicate with the aircraft manufacturer thereby increasing operational efficiency and reducing delays due to a delay in receiving necessary information concerning an aircraft.

By using the systems and methods for delivering backup information to a user, users can download backup files of their documents from an aircraft manufacturer associated with aircrafts owned by an airline to their own local storage media in a viewable format. Thus, if communications cannot be established between the airline and the aircraft manufacturer, the airline can use the backup files to accomplish tasks necessary to maintain airline operations.

The system architecture 100 which may employ communications over the Internet between the batch server 108 and the conversion server 120, or the system architecture 100 may also employ any communications process whereby two or more servers communicate with each other when residing in a common location. The system architecture 100 may also allow the user to modify documents locally and transmit the modified documents to the aircraft manufacturer for storage in the storage device 110.

The invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents.

What is claimed is:

1. A method for delivering backup information to a user, the method comprising:
requesting backup information from an external library;
packaging the requested information into an archive file;
storing the archive file having a first data format;
converting the archive file having a first data format into a backup file having a second data format; and
sending the backup file to the user, wherein the user can use the information within the backup file locally.

2. The method of claim 1, wherein the requesting of backup information includes establishing an Internet connection with the external library.

3. The method of claim 1, wherein the backup file is used by the user when the user cannot establish an Internet connection with the external library.

4. The method of claim 1, wherein the first data format is an XML data format.

5. The method of claim 1, wherein the second data formation is a PDF format.

6. The method of claim 1 further comprising sending the archive file to an external conversion site, wherein the external conversion site converts the archive file having a first data format into a backup file having a second data format.

7. The method of claim 6 further comprising packaging one or more backup files and sending the one or more backup files to the external library.

8. The method of claim 7, wherein the sending of the archive file to the external conversion site and the sending of the one or more backup files to the external library occurs using the Internet.

9. The method of claim 6 further comprising packaging one or more backup files and sending the one or more backup files directly to a local computer of a user that initiated the request for backup information.

10. The method of claim 1 further comprising modifying the requested information and storing the modifications within the archive file.

11. The method of claim 1, wherein the backup files sent to the user are sent automatically.

12. The method of claim 1, wherein the user uses a content delivery manager for requesting backup information from the external library and receiving the backup file from the external library.

13. The method of claim 1, wherein the information is information related to aircrafts.

14. The method of claim 1, wherein the backup information is used to conduct tests on an aircraft.

15. A computer-readable medium which stores a set of instructions which when executed performs a method for delivering backup information to a user, the method executed by the set of instructions comprising:
requesting backup information from an external library;
packaging the requested information into an archive file;
storing the archive file having a first data format;
converting the archive file having a first data format into a backup file having a second data format; and
sending the backup file to the user, wherein the user can use the information within the backup file locally.

16. The computer readable storage medium of claim 15 further comprising sending the archive file to an external conversion site, wherein the external conversion site converts the archive file having a first data format into a backup file having a second data format.

17. A system for delivering backup information to a user, the system comprising:
a client system for requesting backup information from an external library by the user;
said external library configured for packaging the requested information into an archive file;
said external library further configured for storing the archive file having a first data format in a user directory;
said external library further configured for converting the archive file having a first data format into a backup file having a second data format; and
said external library further configured for sending the backup file to client system.

18. The system of claim 17 further comprising an external conversion server configured to receive said archive file having a first data format and convert said archive file into a backup file having a second data format.

19. The system of claim 17 wherein the external library is configured to display a list of data files available, the external library further being configured to facilitate the selection of specific files to be packaged into an archive file.

20. The system of claim 17 further including a document delivery server operatively connected to the external library to facilitate automatic delivery of the backup file to the user.
